(19) United States
(12) Patent Application Publication
(10) Pub. No.: US 2005/0174243 A1
(43) Pub. Date: Aug. 11, 2005

(54) Emergency alarm for shoes

(76) Inventor: Katherine Musil, Tallahassee, FL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/776,673

(22) Filed: Feb. 10, 2004

(51) Int. Cl. G08B 13/00

(52) U.S. Cl. 340/574

(57) ABSTRACT

A warning device for affixation to the top of a shoe; an electronically activated controller affixed to the top of a shoe; activation means for activating the controller; and alarm means generated when the controller is activated.

### FIELD OF THE INVENTION

The present invention is directed to personal protection devices. In particular, the invention is directed to personal protection devices for children and the like.

### BACKGROUND OF THE INVENTION

Personal safety devices are of great importance and have gained great popularity in recent years. In recent years, there have been a number of devices for providing protection to young children, the elderly and the handicapped. Such individuals are particularly susceptible to criminal activity, violence and abduction. There have been a number of technologies directed to personal monitoring and protection.

U.S. Pat. No. 5,748,087, for example, discloses a remote monitoring system, particularly useful in monitoring the position of a child or Alzheimer's patient that has a first unit including a handheld portable transmitter and receiver; and a second unit including two identical sections, wherein each section is carried in one of a footwear pair, and each section has a transmitter and receiver. The transmitter of the first unit has a selective switch for on-demand transmission of a find signal. The transmitters of the second unit each continuously emit a location signal. The receiver of the first or handheld unit is responsive to one of or both location signals. The handheld unit generates an audible alarm indicating that the person wearing the footwear has gone beyond a preset distance from the first or handheld unit.

U.S. Pat. No. 5,500,635 discloses a product, in particular a shoe, apparel, a ball or a fishing lure, incorporating an impact sensing element made from polymeric piezoelectric material. In response to impact, the piezoelectric material generates an electrical signal to a battery-powered light- or sound-emitting unit or to an information display device which is at least partially molded into or contained in the product, thus causing circuitry to energize the light- or sound-emitting device from the battery or to display information on the information display device.

U.S. Pat. No. 5,188,447 discloses a member made from a suitable material such as a polyurethane epoxy designed to withstand impact against an object is provided as a support member. For example, the member may constitute an insert disposed on or in the heel of a shoe but a wide variety of other applications are possible. A suitable member such as a piezoelectric member is disposed on the support member to produce a signal when the support member is impacted against the object or when the impact is released. This signal is amplified by an amplifier which is powered by a suitable source such as a battery.

U.S. Pat. No. 6,313,733 discloses a child pager system including a transmitter unit which may transmit one of a plurality of messages to a select one of a plurality of pager units. The transmitter unit has a plurality of channel selection switches each pre-designated for a particular pager. The transmitter unit also has a plurality of transmission buttons each in communication with a separate light means on a pager unit whereby each transmission button transmits a signal indicating a different level of urgency to the pager carrier. Each pager unit has a panic means in communication with an internal transmission means that is automatically activated when the pager unit is removed from a carrier's belt. A panic signal is then transmitted to the transmitter unit and a light means on the transmitter unit is illuminated indicating which pager unit sent the signal. The panic means also activates a sound recording means on the pager unit whereby the carrier can quickly record a message in the event of an assault or another sudden emergency. The transmitter unit also has a plurality of lights each varying in color for indicating the relative distance of a pager unit in communication therewith.

U.S. Pat. No. 6,262,660 discloses a locator system for determining when an object has entered a predetermined monitoring area. The locator system includes a central base unit and at least one remote unit. The central base unit includes a transmitter for transmitting a monitoring signal within the predetermined area, an alarm signal generator and a receiver. Each of the at least one remote units includes a receiver for receiving the monitoring signal when positioned within the monitoring area and a device for generating and transmitting a response signal for receipt by the receiver in the central base unit. The central base unit is caused to generate an alarm signal upon receipt of the response signal thereby alerting a person monitoring the central base unit that the at least one remote unit has entered the monitoring area. The central base unit may include a device for adjusting a strength of the monitoring signal and thereby adjust the size of the monitoring area. Alternatively, the remote unit may include a device for adjusting a strength of the response signal and thereby adjust the size of the monitoring area. When more than one remote unit is being monitored by the central base unit each of the remote units is identified by a respective identification code, the identification codes being stored within a processor of the central base unit, the identification code being transmitted by respective remote units with the response signal.

U.S. Pat. No. 5,790,949 discloses a paging system communicatively connects a first user initiating a page request using a first telephone to a second user receiving the page request using a second telephone. The paging system includes a paging service transmitter transmitting the page request, and a paging device. The paging device includes a page receiver receiving the page request as a first signal, and a first identification device. The first identification device receives the first signal indicating that the page request was received, and includes an identification transmitter for transmitting a second signal indicating that the second user is ready to be communicatively connected. The paging system includes a second identification device, and receives the second signal transmitted by said first identification device. The second identification device transmits a third signal including a destination number corresponding and addressable to the second telephone. The paging system further includes a page locator device receiving notification of the page request from the first user and receiving the third signal. The page locator device communicatively connects the first user to the second user receiving the page request using the second telephone responsive to the destination number received in the third signal.

European Patent Application No. 121,026 discloses an illuminated sport shoe, particularly for running or jogging, to enhance the safety of the wearer when running when visibility is poor. The shoe includes an upper, and an integral sole and heel piece of resilient material. A cavity is defined in the integral sole and heel piece adjacent the heel portion of the shoe, and a battery, or like source of e.m.f., is mounted in the cavity. A light source, such as an L.E.D., is mounted with the shoe, and one light source can be mounted in the integral sole and heel piece at the heel of the shoe, and another in the upper at the toe portion of the shoe. An integrated circuit chip or mercury switch is provided to effect flashing of the light source when connected to the battery, and a switch is provided for operatively selectively connecting and disconnecting the light source to and from the battery. The chip and battery can be encapsulated in resilient material to provide an insert which has an interference fit with the walls defining the cavity in the integral sole and heel piece of the shoe.

European Patent Application No. 335,467 discloses footwear of different types, such as walking shoes, boots, sport shoes and the like in such a way that the footwear dependent upon the situation and, if desired, controlled by the user, can produce signals that can be perceived by other persons. As an example reference is made to the use of sport shoes by a sportsman in twilight or darkness. In this situation it may be important, if his sport shoes e.g. at the rear side, can produce light that may have a varying position and/or intensity. Also an acoustic signalling is possible. In order to realize the above purpose the invention provides footwear which is characterized by electrically energizable signal means, and a source for electric energy for powering said signal means.

British Patent No. 2,121,219 discloses an apparatus for providing an additional electronic circuit device in a shoe which, upon walking, jogging or running, applies the technique of utilizing a single chip microcomputer, means for counting the number of steps, measuring the approximate distance and counting the time people have walked or run. It also provides the walking speed rate, music beat and beat sound, etc.

WIPO Patent Application No. 8,102,223 is directed to a pressure sensitive apparatus for producing electrical signals on two electrodes having a layered structure consisting of a conductive layer, a piezoelectric polymer film layer, an electrode layer, an insulating layer, another electrode layer, another piezoelectric polymer film layer, and another conductive layer. The layered structure may be constructed from an insulating layer sandwiched between two piezoelectric polymer films each having an electrode on one surface thereof and having a conductive plane on the other surface thereof disposed on each side of the insulating layer with the electrodes in closest proximity to the insulating film. Further, support substrates may be disposed on each side of the piezoelectric polymer films, the support substrates having an opening where the electrodes are located. Still, further, the apparatus may be adapted for a pressure sensitive matrix keyboard having a plurality of keyboard switch positions arranged in a plurality of rows and columns where the electrodes are a strip constituting one of the rows and columns, respectively, of the keyboard switch positions. The piezoelectric polymer film may be polyvinylidene fluoride and the layered structure may be integrally bonded or physically sandwiched together and may have connected to it an electrical sensing circuit suitable for amplifying a small charge pulse induced by the strain upon the piezoelectric polymer film.

WIPO Patent Application No. 8,702,846 is directed towards a touch-sensitive light emitting diode comprising a diode encapsulated in a plastics dome and externally operable touch sensitive switching means positioned within the dome, the switching means including an output to external electronics and the diode providing visual indication of the state of the switching means. The switching means may be a resistive touch switch, a voltage detection touch switch, a capacitance detection touch switch, or a proximity detection touch switch. The switching means may also be in the form of a stress/strain sensitive element or a light sensitive element positioned within the dome to detect an object or finger-tip in proximity to the dome. The light emitting diode may also include an integrated circuit positioned within the dome and the like.

While there are a number of products directed to shoe related lights, sensors, etc, there have not been security systems incorporated within shoes and which can be easily activated. Frequently vulnerable individuals under attack are incapable of defending themselves and are often incapable of screaming for help or assistance. Would be muggers and assailants often attempt to subdue individuals by holding a hand over the victim's mouth. Assailants often attempt to subdue the victim's upper body because that is generally the weaker portion of the victim.

It is more difficult to subdue a victim around his or her feet or legs. This fact makes the legs and feet an ideal location for the placement of personal security devices.

It would be desirable to provide a shoe based personal defense and warning system which can be placed in the top of a shoe and be selectively activated in an emergency situation

It is another object of the present invention to provide a mechanism whereby individuals can be protected by means of an emergency alarm system in the top portion of tongue of a shoe.

These and other objects of the present invention will become clear and apparent from the attached summary and detailed description which follow.

### BRIEF DESCRIPTION OF FIGURES

FIG. 1 is a side perspective view of the shoe based defense and alarm system of the present invention within a shoe

FIG. 2 is an isolated view of the shoe based defense and alarm system.

FIG. 3 represents a block diagram of the circuitry of the present invention.

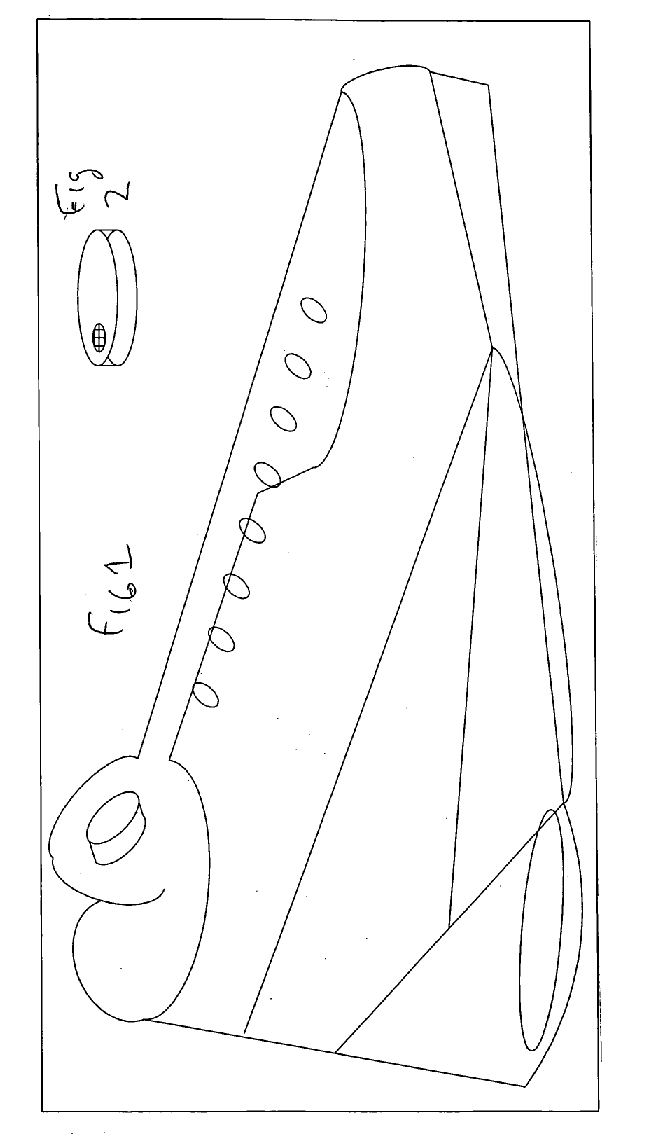

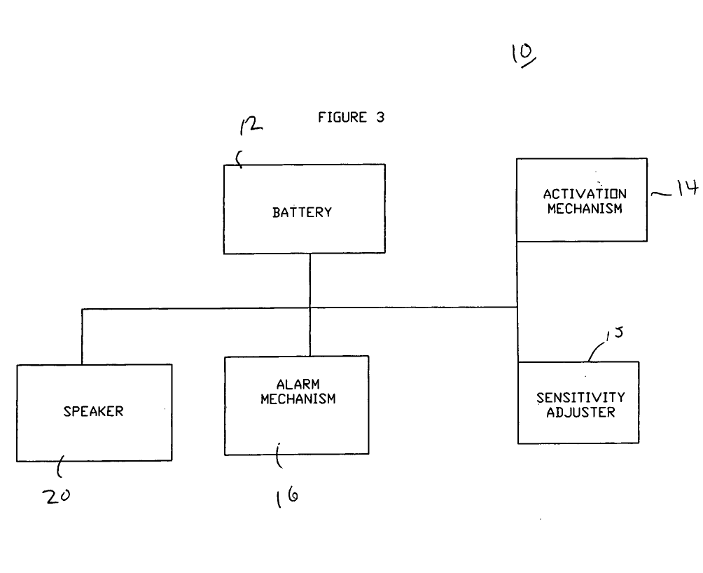

### DETAILED DESCRIPTION OF THE PREFERRED EMBODIMENT

The present invention is described with reference to the enclosed Figures wherein the same numerals are utilized where applicable. In a most preferred embodiment, the present invention broadly comprises a system for monitoring and protecting a child or potential victim from abduction or violence. For purposes of the disclosure, the term potential victim comprises any individual such as a child, elderly person or invalid who may be prone to a physical or violent attack and unable to adequately defend himself or herself.

The invention is directed to a device 10 that can be attached to the upper portion of a shoe 12, proximate to the top of the shoe tongue which may be activated by violent depression or kicking by the victim wearer. The device, in one embodiment is approximately 1.5 inches in length and approximately ½ inch in width. The device 10 includes an small battery power supply 12, and activation mechanism 14 and an alarm mechanism 16. The system should also preferably include a mechanism to adjust the sensitivity 15 of the system. The alarm mechanism may comprise a beeper or transmitter to alert law enforcement and the like via speaker 20.

In one embodiment, the activation mechanism comprises a piezoelectric or other pressure sensor 14 which is activated by the compression or activation by the victim's other foot, when under attack. In substance, when under attack, the victim stamps his or her other foot on the device. Alternatively, the activation mechanism 14 may comprise an accelerometer which activates by violent kicking. It is to be appreciated that a wide range of mechanisms can be used in the present invention. Upon activation, an alarm or beep sounds out of the system.

It is to be appreciated that the present invention, particularly when used with children is preferably removable and may be attached by Velcro or other means. The invention envisions situations such as adult supervised activities where the risk to the child does not warrant the use of the device. The device may be attached when a child is taken on a trip or when a child is taken to a mall where the risk of assault or abduction is greater.

In one embodiment, the system comprises a device which functions as a personal emergency alarm. The wearer can stomp the top of the foot with the device in an emergency (or violently strike the leg), which will then activate the device, emitting a loud audible alarm sound. The alarm sound can be verbal such as “I am under attack,” “call the police,” or “call 9-1-1.” The system can also include a defense packet which emits a strong chemical odor.

Violent kicking can activate the alarm via an accelerometer. The present invention comprises a unique device, which is situated with a child's shoe and which is designed to be activated by the child pressing down on the foot.

The invention can also be set up to send out an alarm to police and law enforcement. It can also be set up as a monthly subscription service which is notified when the alarm is activated.

The present invention has been described in accordance with the above discussed preferred embodiment. It is to be appreciated that other embodiments fulfill the spirit and scope of the present invention and that the true nature and scope of the invention is to be determined with reference to the claims appended hereto.

1. A warning device for affixation to the top of a shoe comprising
an electronically activated controller affixed to the top of a shoe;
activation means for activating the controller; and
alarm means generated when the controller is activated.

2. A warning device for affixation to top of a shoe;
an electronically activated controller remaining affixed to the top of a shoe;
pressure-based activation means for activating the controller when depressed by the other foot of the wearer; and
an alarm means for generating a distress signal.

3. A warning device for affixation to inside tongue of a shoe;
an electronically activated controller remaining affixed to the inside of the tongue of a shoe;
accelerometer-based activation means for activating the controller upon violent kicking by the wearer; and
an alarm means for generating a distress signal upon the activation of the activation means.
